(19) United States
(12) Patent Application Publication
(10) Pub. No.: US 2024/0128779 A1
(43) Pub. Date: Apr. 18, 2024

(54) METHOD OF MANAGING HETEROGENEOUS BATTERY COMPONENTS IN SERIES

(71) Applicant: Relyion Energy, Inc., Fremont, CA (US)

(72) Inventors: Surinder SINGH, Fremont, CA (US); Ratnesh K. Sharma, Fremont, CA (US)

(73) Assignee: Relyion Energy, Inc., Fremont, CA (US)

(21) Appl. No.: 18/046,298

(22) Filed: Oct. 13, 2022

(51) Int. Cl. H02J 7/00; H01M 10/48; H01M 50/51

(52) U.S. Cl. CPC H02J 7/00711; H01M 10/482; H01M 50/51; H02J 7/0013; H02J 7/0048

(57) ABSTRACT

Described herein are methods of managing series of heterogeneous battery components that can include the steps of: for each of a plurality of terminal sets having one or more adjacent terminals in the series, measuring a respective voltage difference and a respective current draw over a period of time for the terminal set, and calculating a respective normalized parameter value for the terminal set based on the respective voltage difference and the respective current draw for the terminal set; based on normalized parameter values for two or more terminal sets in the series, calculating a statistical measure of the normalized parameter values; determining a switching duty cycle based on the statistical measure; and activating a relay in electrical communication with at least one of the terminal sets in the series using a pulse-width modulated signal having the determined switching duty cycle.

### FIELD

This disclosure relates generally to battery components connected in series, and more specifically, to methods of managing series of heterogeneous battery components with divergent voltage and current characteristics.

### BACKGROUND

Batteries comprise voltage sources with capacitance created by the accumulation of charge at the electrodes. Various mechanisms lead to degradation of batteries, which can impede the flow of charge between the electrodes.

### SUMMARY

A battery pack (which may simply be referred to as a “battery”) may be used to power an electric device, such as an electric vehicle. The terms “battery” and “battery pack,” as used herein, may refer to devices that include multiple components, or building blocks, that make up the entire battery system. As used herein, the term “components” may be used to refer to battery cells and/or battery modules of a battery system. As used herein, a battery “cell” may refer to the most fundamental component of a battery system, the cell itself comprising a cathode and an anode. A plurality of cells may together make up a battery “module,” as the terms may be used herein. Finally, a plurality of modules may together make up an entire battery or battery system, as the terms may be used herein. Because a battery system may be made up of smaller components and sub-components, the performance of the entire battery system can be optimized by managing its various components and sub-components (e.g., modules and cells) when they are connected together in series. Finally, the term “battery series” as used herein refers to a battery or battery pack in which one or more components of the battery or battery pack are connected to one another in series.

When battery components such as modules or cells are connected in series, each component may degrade at different rates due to varying battery chemistries, leading to different states of health (SOH) of each battery component in the series. When such components are assembled in series to a load or an inverter in a single string, the voltage drop between each component can be different. This heterogeneity can lead to disparate loss of capacity and aggravate further degradation of components to an extent that some components can reach end of life earlier than in a balanced series. Additionally, unintended high discharge due to a weak cell can lead to thermal runaway and create fire/safety issues. Accordingly, there is a need for improved systems and methods for managing series of heterogeneous battery components having different voltage and current characteristics. Furthermore, there is a need for systems and methods for automatically managing the operation of heterogeneous battery components by altering the charge/idle state of the components without requiring knowledge of the battery chemistry for each component. Described herein are systems and methods that may address the above-identified need.

Described herein are methods of managing series of battery components where one or more components in the series may be “weaker” than the others. As a battery series discharges and current passes through a weak component in the series, voltage may drop by a greater amount relative to a voltage drop at other components in the series. As such, the methods described herein can be used to detect weak components in the series by quantifying and comparing a voltage drop at each component and then switching the flow of current so as to interrupt the voltage drop at the weak component, thus optimizing the performance of the entire series.

In some embodiments, a method of managing a series of heterogeneous battery components is provided, the method comprising: determining a switching duty cycle to be applied to at least one terminal set of a plurality of terminal sets comprising two or more adjacent terminals in the series; and activating a relay in electrical communication with the at least one of the terminal sets in the series using a pulse-width modulated signal having the determined switching duty cycle.

In some embodiments, the method comprises: for each of a plurality of terminal sets comprising two or more adjacent terminals in the series, measuring a respective voltage difference and a respective current draw over a period of time for the terminal set; wherein determining the switching duty cycle comprises determining the switching duty cycle based on the respective voltage differences and respective current draws.

In some embodiments, the method comprises: for each of the plurality of terminal sets, calculating a respective normalized parameter value for the terminal set based on the respective voltage difference and the respective current draw for the terminal set; wherein determining the switching duty cycle comprises determining the switching duty cycle based on the respective normalized parameter values.

In some embodiments, the method comprises: based on normalized parameter values for two or more terminal sets in the series, calculating a statistical measure of the normalized parameter values; wherein determining the switching duty cycle comprises determining the statistical measure of the normalized parameter values.

In some embodiments, the method comprises: after activating the relay, determining that one or more steady-state criteria for the series have not been satisfied; and in accordance with determining that the one or more steady-state criteria for the series have not been satisfied, repeating the steps of measuring a respective voltage difference and a respective current draw, calculating a respective normalized parameter, calculating a statistical measure of the normalized parameter values, determining a switching duty cycle based on the statistical measure, and activating a relay.

In some embodiments, the method comprises: selecting the relay from a group of relays in electrical communication with the series, wherein selecting the relay is based on the statistical measure.

In some embodiments, the method comprises: selecting the relay from a group of relays in electrical communication with the series, wherein selecting the relay is based on a second statistical measure different from the first statistical measure, wherein the second statistical measure is calculated based on the normalized parameter values for the two or more terminal sets in the series.

In some embodiments, the statistical measure comprises an option selected from the group: maximum of the normalized parameter values, minimum of the normalized parameter values, mode of the normalized parameter values, median of the normalized parameter values, mean of the normalized parameter values, and range of the normalized parameter values.

In some embodiments: activating a relay is performed as part of a coordinated multi-relay control process based on the determined switching duty cycle.

In some embodiments: the voltage difference and current draw are measured over a period of 5-15 seconds.

In some embodiments, the method comprises: adjusting the period of time of the voltage difference and current draw measurement based on a magnitude of the voltage difference.

In some embodiments, the method comprises: adjusting the period of time of the voltage difference and current draw measurement based on a desired ramp rate for the series of heterogeneous battery components.

In some embodiments, the method comprises: adjusting the period of time of the voltage difference and current draw measurement based on a charge level of the series of heterogeneous battery components.

In some embodiments: activating a relay comprises setting an amplitude and an offset of the pulse-width modulated signal based on an external application requirement of the series.

In some embodiments: the series of heterogeneous battery components comprises components having different battery chemistries.

In some embodiments: the series of heterogeneous battery components comprises components having different ages.

In some embodiments: the series of heterogeneous battery components comprises components having different form factors.

In some embodiments: the series of heterogeneous battery components comprises components having different structural arrangements.

In some embodiments: the series of heterogeneous battery components comprises components having different performance characteristics.

In some embodiments, a system is provided, the system comprising: a series of heterogeneous battery components; a relay in electrical communication with at least one terminal set of a plurality of terminal sets comprising two or more adjacent terminals in the series; and one or more processors configured to: determine a switching duty cycle to be applied to the at least one terminal set in the series; and activate a relay in electrical communication with the at least one of the terminal sets in the series using a pulse-width modulated signal having the determined switching duty cycle.

In some embodiments, a non-transitory computer-readable storage medium is provided, the non-transitory computer-readable storage medium storing instructions, the instructions executable by one or more processors of a system comprising a series of heterogeneous battery components to cause the system to: determine a switching duty cycle to be applied to at least one terminal set of a plurality of terminal sets comprising two or more adjacent terminals in the series; and activate a relay in electrical communication with the at least one of the terminal sets in the series using a pulse-width modulated signal having the determined switching duty cycle.

It will be appreciated that any of the variations, aspects, features and options described in the methods herein can apply equally to other systems, other methods, and vice versa.

It will also be clear that any one or more of the above variations, aspects, features and options can be combined.

Additional advantages will be readily apparent to those skilled in the art from the following detailed description. The aspects and descriptions herein are to be regarded as illustrative in nature and not restrictive.

All publications, including patent documents, scientific articles and databases, referred to in this application are incorporated by reference in their entirety for all purposes to the same extent as if each individual publication were individually incorporated by reference. If a definition set forth herein is contrary to or otherwise inconsistent with a definition set forth in the patents, applications, published applications and other publications that are herein incorporated by reference, the definition set forth herein prevails over the definition that is incorporated herein by reference.

### BRIEF DESCRIPTION OF THE FIGURES

The invention will now be described, by way of example only, with reference to the accompanying drawings, in which:

FIG. 1 illustrates an exemplary arrangement for a battery series, in accordance with some embodiments;

FIG. 2 illustrates a method of managing heterogeneous battery components in series in accordance with some embodiments;

FIG. 3 illustrates a pulse-width modulated signal in accordance with some embodiments;

FIG. 4 illustrates a computer, in accordance with some embodiments.

In the figures, like reference numbers refer to like components unless stated herein to the contrary.

### DETAILED DESCRIPTION

Reference will now be made in detail to implementations and embodiments of various methods described herein. Although several exemplary variations of methods are described herein, other variations can include aspects or steps of the methods described herein combined in any suitable manner having combinations of all or some of the aspects described. For example, variations of the methods described herein can be used to manage other power sources connected in series or other configurations of batteries.

Disclosed herein are methods for managing heterogeneous battery components connected in series. In some embodiments, the methods described herein can be performed without the need for knowledge of the underlying chemistry of the battery components. Further, the methods described herein do not require the use of balancing methods with passive or active means of discharging components, which may not address the heterogeneity of the components and can increase throughput and degradation of battery health. In some embodiments, the methods described herein use fast switching to interrupt the drain of weak battery components, allowing them to recover from severe voltage drops and protect components from potential damage. As such, the methods disclosed herein can optimize the performance of heterogeneous battery series and improve safety by reducing thermal runaway and risk of fire.

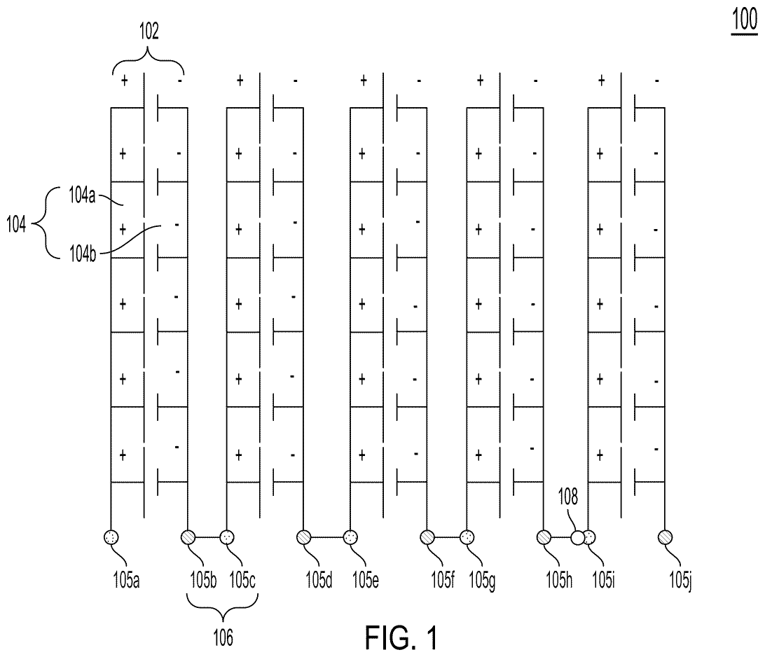

Disclosed herein are methods for managing heterogeneous battery components connected in series by altering the charge/idle state of battery components. FIG. 1 shows an exemplary battery series 100 including battery components 102 (only one of which is labeled for simplicity) that can be managed by the methods described herein. Components 102 are connected in series. In some embodiments, components 102 may be battery modules. In some embodiments, components 102 may be battery cells. Each component 102 in the series can be made up of sub-components 104 (only one of which is labeled for simplicity). Thus, the exemplary series 100 shown in FIG. 1 depicts five components 102 connected in series, each having six sub-components 104. However, battery series having more components/sub-components or fewer components/sub-components may be managed by the systems and methods described herein. As shown, sub-component 104 may include its own sub-terminals 104a and 104b that may be connected in parallel, but the terminals connected in series at the end of components 102 (e.g. 105b, 105c) are the focus of the methods described herein.

In some embodiments, components of series 100 (including component 102) may be battery modules and/or battery cells. In some embodiments, sub-components of series 100 (including sub-component 104) may be battery modules and/or battery cells. As such, in some embodiments, series 100 may include five modules (including component 102) connected in series and each made up of six sub-modules (including sub-component 104); in some embodiments, series 100 may include five modules (including component 102) connected in series and each made up of six cells (including sub-component 104); in some embodiments, series 100 may include five cells (including component 102) connected in series and each made up of six sub-modules (including sub-component 104). In some embodiments, the compositions of the different components connected in series may vary structurally with respect to one another, such that some of the components may be modules and some may be cells, and/or such that some of the components may be made up of sub-components and some may be made up of cells.

As shown in FIG. 1, in some embodiments, each component may have terminals 105a-105j located on either end of the component. For example, the leftmost component 102 includes terminals 105a and 105b. In some embodiments, terminals between adjacent components may be connected in series so as to form terminal sets 106 (only one of which is labeled for simplicity), such as with terminals 105b and 105c. Terminal sets 106 may be referred to herein with respect to calculation of certain parameters/metrics for a terminal set. For example, calculations of certain parameters/metrics can be performed on terminal set 106 having terminals 105b and 105c. However, the first and last terminals in the series, 105a and 105j, may not be included in the calculation of certain parameters/metrics since they are not part of a terminal set 106.

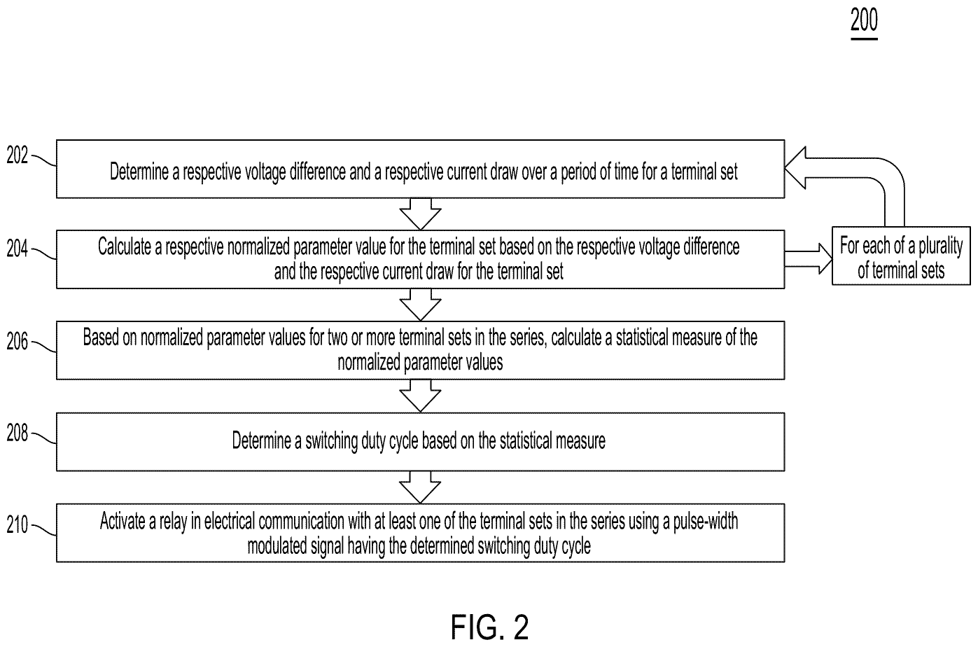

FIG. 2 shows a method 200 for managing heterogeneous battery components connected in series, in accordance with some embodiments. In some embodiments, method 200 may be performed to manage battery components connected in series such as battery series 100 shown and described with respect to FIG. 1. In some embodiments, method 200 may be performed in whole or in part by one or more systems comprising one or more processors configured to execute instructions stored on a computer-readable storage medium to cause the one or more processors and/or an associated battery series (e.g., series 100) to perform the steps of method 200.

At block 202, in some embodiments, the system may determine a respective voltage difference and a respective current draw over a period of time for a terminal set (e.g., a terminal set 106, such as the set comprising terminals 106b and 106c).

In some embodiments, current can be measured using an amp meter connected at a point in the series. Current draw in amp hours (Ah) can be determined by collecting data from the amp meter in quick succession over a time interval. In some embodiments, current draw can be determined over a suitable time period, such as a period greater than or equal to 1, 2, 3, 4, 5, 6, 7, 8, 9, or 10 seconds and less than or equal to 6, 7, 8, 9, 10, 11, 12, 13, 14, or 15 seconds. In some embodiments, a voltage (V) difference can be calculated for each terminal set over the time period of the current draw measurement (Ah). For example, if current draw is determined over a period of 5 seconds, the voltage difference for each terminal set can be determined over the same 5-second period. In some embodiments, the time period of the voltage difference/current draw measurement can be prescribed.

In some embodiments, the time period can be adjusted based on the magnitude of the voltage difference. For example, if the voltage different is insignificant over a shorter time period, a longer time period may be used for the voltage difference/current draw measurement.

In some embodiments, the time period can be adjusted based on a desired ramp rate of the application, for example as per interconnection requirements.

In some embodiments, the time period can be adjusted based on a charge level of the series of heterogeneous battery components. For example, at lower state of charge, the time period may be reduced.

In some embodiments, the system may determine a respective voltage difference and respective current draw for one or more terminal sets for a battery series, including determining respective voltage differences and respective current draws for each terminal set connecting two components in series.

At block 204, in some embodiments, the system may calculate a respective normalized parameter value for the terminal set for which a respective voltage difference and a respective current draw were determined (and/or for all terminal sets in the series), in accordance with some embodiments. In some embodiments, the system may calculate the respective normalized parameter value for a terminal set based on the determined voltage difference and the determined current draw for a terminal set.

In some embodiments, voltage difference and current draw for a terminal set can be used to calculate a parameter R. Parameter R can be calculated for each terminal set in the series, for example in accordance with the following equation:

$${R}_{i}^{k} = ( \frac{{V}_{i + 1}^{k + 1} - {V}_{i}^{k}}{{Ah}_{i}^{k}} )$$

where V represents the voltage drop, Ah represents the current draw, k represents time, and i represents the terminal set (e.g. in calculating R of the first terminal set 106 labeled in FIG. 1, i would be 1).

In some embodiments, the respective normalized parameter value for the terminal set can be a normalized value of parameter R. The respective normalized parameter value R* can be calculated for each terminal set in the series in accordance with the following equation:

$${( {R}_{i}^{k} )}^{*} = \frac{{R}_{i}^{k}}{{\sum }_{j}^{n} {R}_{j}^{k}}$$

where k represents time, i represents the terminal set, n represents the number of terminal sets, and j is a counter from 1 to n for the summation of R values over all terminal sets. The summation can be carried out over the same time period as the current draw and voltage calculation.

In some embodiments, steps 202 and 204 can be performed for each terminal set connecting two battery components in a series. Steps 202 and 204 may, in some embodiments, be performed simultaneously for each terminal set, or one after the other for each terminal set in rapid succession. Determining a respective voltage difference and a respective current draw over a period of time and calculating a respective normalized parameter value for the terminal set based on the respective voltage difference and the respective current draw for the terminal set can be repeated for each of a plurality of terminal sets.

For example, referring to FIG. 1, a respective voltage difference, current draw, and normalized parameter value can be determined for each of (or for each of any respective subset of) the four terminal sets 106. The normalized parameter value of each terminal set 106 can be used to determine the relative state-of-health (SOH) of each component 102 in the series to see if there is a weak component in the series. For example, there may be a voltage difference if a terminal set includes terminals from different components that are connected in series (e.g. terminal set 106 has the pair 105b and 105c that connects two components) due to one of the components being weaker than the other. This voltage difference can be determined for each terminal set over a given time period (e.g. the current draw period) and used to compute a normalized parameter value. For example, a normalized parameter value can be calculated for the terminal set 106 having the pair 105b and 105c, 105d and 105e, and so on, to determine the relative SOH of each component 102 in the series. However, the first and last terminals in the series, 105a and 105j, may not be included in the calculation of the normalized parameter value since they are not part of a terminal set 106.

At block 206, in some embodiments, the system may calculate a statistical measure of the normalized parameter values, wherein the statistical measure is calculated based on normalized parameter values for two or more terminal sets for the series.

In some embodiments, a statistical measure of the normalized parameter values can include, or can be, a maximum value, a minimum value, a mode, a median, a mean, and/or a range (e.g. R*ₘₐₓ-R*ₘᵢₙ) of the set of respective normalized parameter values for two or more (e.g., each) terminal set in the series.

At block 208, in some embodiments, the system may determine a switching duty cycle based on the statistical measure. First, the normalized parameter can be used proportionately to reduce the duty cycle of the pulse. For example, duty cycle can be a product of a multiplier and the parameter. This multiplier can be unity or a number less than unity, determined by heuristics. Ultimately, the voltage difference value (Vᵢ₊₁^{k+1}−Vᵢ^{k}) among the terminal sets should be within a certain standard deviation like 36 or less. Any advanced control algorithm or PI can be used to change the duty cycle. If the voltage difference cannot be brought within a certain standard deviation without significantly altering the battery operation, the system may go into fault status, which may indicate that a module may need replacement.

At block 210, in some embodiments, the system may activate a relay in electrical communication with at least one of the terminal sets in the series using a pulse-width modulated signal having the determined switching duty cycle. In the example of series 100 in FIG. 1, relay 108 can be activated (e.g., turned on) based on the switching duty cycle so as to interrupt the flow of current through a weak component and thus decrease the voltage difference between the weak component and the other components in the series. In some embodiments, relay 108 can be in electrical communication with a terminal set anywhere in the series. In some embodiments, the switching imposed by the relay using the pulse-width modulated signal having the determined switching duty cycle can be in a 1-10 kHz range so as to not create inrush current and heat generation within components 102. For example, the inrush current may be less than or equal to 1, 2, 3, 4, 5, 6, 7, 8, 9, or 10 kHz.

In some embodiments, prior to the step of activating the relay 210, the system may select the relay from amongst a plurality of available relays. For example, a battery series may include a plurality of available relays each attached to a different respective terminal (or to a different respective set of terminals. The system may select one of the relays to activate based on the measured voltage difference and or current draw for a terminal or terminals associated with the selected relay, may select one of the relays to activate based on a parameter and/or normalized parameter associated with the selected relay, and/or may select one of the relays to activate based on a statistical measure of the normalized parameter as calculated based on two or more of the terminals or two or more of the sets of terminals. In some embodiments, the system may identify which set of terminals has a highest normalized parameter (e.g. R*ₘₐₓ) and may select the associated relay for activation. In this manner, R*ₘₐₓ may be a statistical measure used to select the relay. The statistical measure used to select the relay to activate may be a same statistical measure or a different statistical measure from the one that is used to determine a duty cycle by which to activate the selected relay.

In some embodiments, selecting the relay that is triggered by a pulse-width modulated signal is based on which relay from a group of relays in electrical communication with the series corresponds to a selected statistical measure of R*. For example, if there is more than one relay, the relay that is activated may correspond to the terminal having R*ₘₐₓ if R*ₘₐₓ is the chosen statistical measure for selecting a relay. In some embodiments, the statistical measure and the activated relay may be chosen based on which measure will have the least performance impact on the series. For example, selecting R*ₘₐₓ may be a conservative choice because the weakest component would be used to determine the switching duty cycle applied to the entire series. Conversely, choosing R*ₘₑₐₙ may be less conservative because a stronger component may be used to determine the switching duty cycle applied to the entire series.

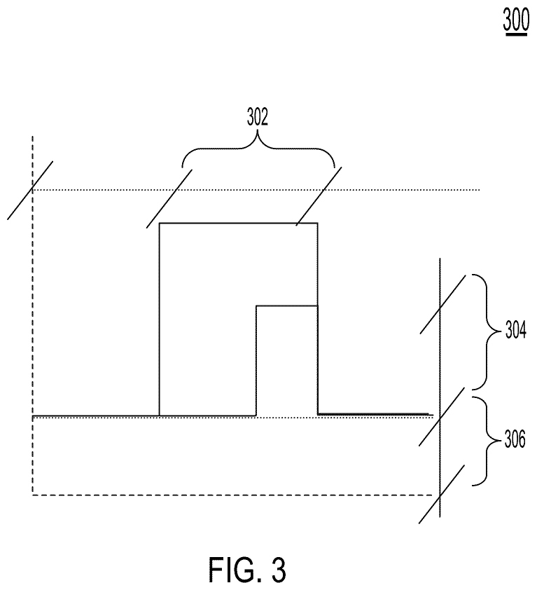

FIG. 3 shows a pulse-width modulated signal 300, in accordance with some embodiments. Pulse-width modulated signal 300 is an example of a pulse-width modulated signal that can activate a relay as described above in blocks 208-210 of FIG. 2. In some embodiments, pulse-width modulated signal 300 can have a switching duty cycle 302 that is determined based on a statistical measure of normalized parameter values calculated based on voltage differences and current draws for terminal sets of a battery series. As described above, switching duty cycle 302 can be determined by using the normalized parameter values can be used proportionately to reduce the switching duty cycle 302 of the pulse. For example, switching duty cycle 302 will be a product of a multiplier and the normalized parameter value. This multiplier can be unity or a number less than unity, determined by heuristics. In some embodiments, based on signal 300, the relay (e.g. relay 108 in FIG. 1) can be automatically switched on or off in accordance with the determined switching duty cycle 302.

In some embodiments, signal 300 can have an amplitude 304 and an offset 306. In some embodiments, amplitude 304 and offset 306 may be prescribed, fixed, predetermined, or calculated using any suitable method prior to imposing the switching duty cycle on the series. For example, the pulse-width modulated signal 300 can have the determined switching duty cycle 302, an amplitude 304 and an offset 306 based on an external application requirement of the series. For example, if an external application requirement is for the battery series to be used in a consumer electronic device, an amplitude and an offset of the pulse-width modulated signal can be calculated to optimize the charge/discharge of the series as it will be used to power the device. For large scale grid applications and EV charging applications, this approach can be used to manage the real time charge/discharge operation while ensuring the safety and long-term health of the energy storage system.

In some embodiments, performance of the battery series may be monitored during and/or after application of the signal by the selected one or more relays.

In some embodiments, the system may determine based on monitored performance whether battery series performance meets one or more steady-state criteria. For example, if performance of the battery series is sufficiently strong, sufficiently stable (temporally), and/or sufficiently homogenous amongst different battery components in the series, then the system may determine that steady-state criteria are met and may therefore cease applying signals via relays. If, however, steady-state criteria are determined not to be met, then the system may iterate the steps described herein to measure voltage, determine parameters and normalized parameters, determine a duty cycle, select one or more relays, and apply a signal via the selected relay(s) using the determined duty cycle. These iterations may continue until one or more steady-state criteria are met.

In some embodiments, steady state criteria may include that each terminal set in the series has the same voltage difference over a given period of time, which would suggest that the series is at steady state and there is no longer a “weak component” in the series after the method has been carried out. In some embodiments, steady state criteria may include that the voltage difference value for each component is within a certain standard deviation of R*ₘₑₐₙ, such as 3σ, 2σ, or 1σ.

In some embodiments, the system may determine based on monitored performance whether to alter an amplitude and/or offset of the signal used to activate the relay. In some embodiments, amplitude and/or offset can be modified based on a PID controller so as not to drastically reduce the performance. In some embodiments, offset 306 can represent an “off” state of a relay, while amplitude 304 may represent an “on” state. For example, amplitude may be a number between 0-1. Signal 300 can be a function used as a filter (or convolution function) on an actual power curve. Amplitude, offset and duty cycle may be needed to synthesize this filter. The switching duty cycle can be derived from the methods described herein. Amplitude and offset can be fixed based on the external application requirement. If the external application can tolerate interruption, offset can be reduced to zero. In some embodiments, amplitude may be limited so as to maintain an inrush current of less than or equal to 1, 2, 3, 4, 5, 6, 7, 8, 9, or 10 kHz.

In some embodiments, given the nature of current flow through components connected in series, the relay that is activated may be located anywhere in the series. In some embodiments, there may be multiple relays at various points throughout the series. In some embodiments, multiple relays can be triggered and can implement the determined switching duty cycle in a coordinated manner. For example, in some embodiments, activating the relay corresponding to the selected statistical measure can be performed as part of a coordinated multi-relay control process (e.g. switching the flow of current at multiple points in the series at once) based on the determined switching duty cycle. In some embodiments, a coordination for a coordinated multi-relay control process may be limited by a minimum required discharge value for a battery in the system. In some embodiments, to protect the system from a sudden change in discharge power, a similar limit may be placed on a time rate of change of discharge power.

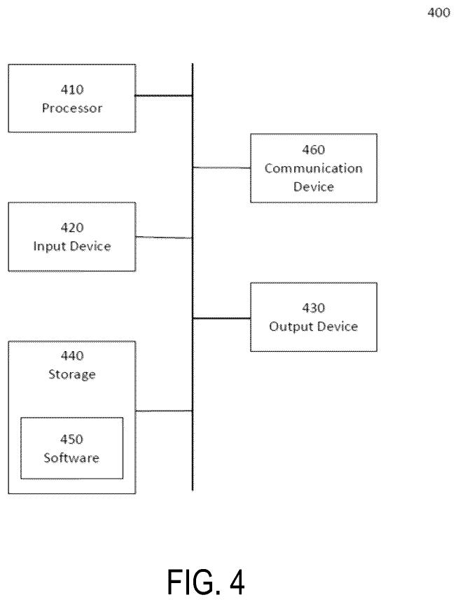

FIG. 4 illustrates an example of a computing system 400, in accordance with some examples of the disclosure. System 400 can be configured to perform (alone or in combination with one or more other systems), in whole or in part, any of the methods described herein, for example by being configured to monitor performance of a multi-component battery series and to compute parameters and statistical measures for controlling relays to control manage performance of the battery series.

System 400 can be a client or a server. As shown in FIG. 4, system 400 can be any suitable type of processor-based system, such as a personal computer, workstation, server, handheld computing device (portable electronic device) such as a phone or tablet, or dedicated device. The system 400 can include, for example, one or more of input device 420, output device 430, one or more processors 410, storage 440, and communication device 460. Input device 420 and output device 430 can either be connectable or integrated with the computer.

Input device 420 can be any suitable device that provides input, such as a touch screen, keyboard or keypad, mouse, gesture recognition component of a virtual/augmented reality system, or voice-recognition device. Output device 430 can be or include any suitable device that provides output, such as a display, touch screen, haptics device, virtual/augmented reality display, or speaker.

Storage 440 can be any suitable device that provides storage, such as an electrical, magnetic, or optical memory including a RAM, cache, hard drive, removable storage disk, or other non-transitory computer readable medium. Communication device 460 can include any suitable device capable of transmitting and receiving signals over a network, such as a network interface chip or device. The components of the computing system 400 can be connected in any suitable manner, such as via a physical bus or wirelessly.

Processor(s) 410 can be any suitable processor or combination of processors, including any of, or any combination of, a central processing unit (CPU), field programmable gate array (FPGA), and application-specific integrated circuit (ASIC). Software 450, which can be stored in storage 440 and executed by one or more processors 410, can include, for example, the programming that embodies the functionality or portions of the functionality of the present disclosure (e.g., as embodied in the devices as described above)

Software 450 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 440, that can contain or store programming for use by or in connection with an instruction execution system, apparatus, or device.

Software 450 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate or transport programming for use by or in connection with an instruction execution system, apparatus, or device. The transport computer readable medium can include, but is not limited to, an electronic, magnetic, optical, electromagnetic, or infrared wired or wireless propagation medium.

System 400 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

System 400 can implement any operating system suitable for operating on the network. Software 450 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

Reference to “about” a value or parameter herein includes (and describes) variations that are directed to that value or parameter per se. For example, description referring to “about X” includes description of “X”. In addition, reference to phrases “less than”, “greater than”, “at most”, “at least”, “less than or equal to”, “greater than or equal to”, or other similar phrases followed by a string of values or parameters is meant to apply the phrase to each value or parameter in the string of values or parameters.

As used herein, the singular forms “a,” “an,” and “the” are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, components, components, and/or units but do not preclude the presence or addition of one or more other features, integers, steps, operations, components, components, units, and/or groups thereof.

This application discloses several numerical ranges in the text and figures. The numerical ranges disclosed inherently support any range or value within the disclosed numerical ranges, including the endpoints, even though a precise range limitation is not stated verbatim in the specification because this disclosure can be practiced throughout the disclosed numerical ranges.

The above description is presented to enable a person skilled in the art to make and use the disclosure and is provided in the context of a particular application and its requirements. Various modifications to the preferred embodiments will be readily apparent to those skilled in the art, and the generic principles defined herein may be applied to other embodiments and applications without departing from the spirit and scope of the disclosure. Thus, this disclosure is not intended to be limited to the embodiments shown but is to be accorded the widest scope consistent with the principles and features disclosed herein.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated. For the purpose of clarity and a concise description, features are described herein as part of the same or separate embodiments; however, it will be appreciated that the scope of the disclosure includes embodiments having combinations of all or some of the features described.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A method of managing a series of heterogeneous battery components, the method comprising:
determining a switching duty cycle to be applied to at least one terminal set of a plurality of terminal sets comprising two or more adjacent terminals in the series; and
activating a relay in electrical communication with the at least one of the terminal sets in the series using a pulse-width modulated signal having the determined switching duty cycle.

2. The method of claim 1, comprising:
for each of a plurality of terminal sets comprising two or more adjacent terminals in the series, measuring a respective voltage difference and a respective current draw over a period of time for the terminal set;
wherein determining the switching duty cycle comprises determining the switching duty cycle based on the respective voltage differences and respective current draws.

3. The method of claim 2, comprising:
for each of the plurality of terminal sets, calculating a respective normalized parameter value for the terminal set based on the respective voltage difference and the respective current draw for the terminal set;
wherein determining the switching duty cycle comprises determining the switching duty cycle based on the respective normalized parameter values.

4. The method of claim 3, comprising:
based on normalized parameter values for two or more terminal sets in the series, calculating a statistical measure of the normalized parameter values;
wherein determining the switching duty cycle comprises determining the statistical measure of the normalized parameter values.

5. The method of claim 1, comprising:
after activating the relay, determining that one or more steady-state criteria for the series have not been satisfied; and
in accordance with determining that the one or more steady-state criteria for the series have not been satisfied, repeating the steps of measuring a respective voltage difference and a respective current draw, calculating a respective normalized parameter, calculating a statistical measure of the normalized parameter values, determining a switching duty cycle based on the statistical measure, and activating a relay.

6. The method of claim 1, comprising selecting the relay from a group of relays in electrical communication with the series, wherein selecting the relay is based on the statistical measure.

7. The method of claim 1, comprising selecting the relay from a group of relays in electrical communication with the series, wherein selecting the relay is based on a second statistical measure different from the first statistical measure, wherein the second statistical measure is calculated based on the normalized parameter values for the two or more terminal sets in the series.

8. The method of claim 1, wherein the statistical measure comprises an option selected from the group: maximum of the normalized parameter values, minimum of the normalized parameter values, mode of the normalized parameter values, median of the normalized parameter values, mean of the normalized parameter values, and range of the normalized parameter values.

9. The method of claim 1, wherein activating a relay is performed as part of a coordinated multi-relay control process based on the determined switching duty cycle.

10. The method of claim 1, wherein the voltage difference and current draw are measured over a period of 5-15 seconds.

11. The method of claim 1, comprising adjusting the period of time of the voltage difference and current draw measurement based on a magnitude of the voltage difference.

12. The method of claim 1, comprising adjusting the period of time of the voltage difference and current draw measurement based on a desired ramp rate for the series of heterogeneous battery components.

13. The method of claim 1, comprising adjusting the period of time of the voltage difference and current draw measurement based on a charge level of the series of heterogeneous battery components.

14. The method of claim 1, wherein activating a relay comprises setting an amplitude and an offset of the pulse-width modulated signal based on an external application requirement of the series.

15. The method of claim 1, wherein the series of heterogeneous battery components comprises components having different battery chemistries.

16. The method of claim 1, wherein the series of heterogeneous battery components comprises components having different ages.

17. The method of claim 1, wherein the series of heterogeneous battery components comprises components having different form factors.

18. The method of claim 1, wherein the series of heterogeneous battery components comprises components having different structural arrangements.

19. The method of claim 1, wherein the series of heterogeneous battery components comprises components having different performance characteristics.

20. A system comprising:
a series of heterogeneous battery components;
a relay in electrical communication with at least one terminal set of a plurality of terminal sets comprising two or more adjacent terminals in the series; and
one or more processors configured to:
determine a switching duty cycle to be applied to the at least one terminal set in the series; and
activate a relay in electrical communication with the at least one of the terminal sets in the series using a pulse-width modulated signal having the determined switching duty cycle.

21. A non-transitory computer-readable storage medium storing instructions, the instructions executable by one or more processors of a system comprising a series of heterogeneous battery components to cause the system to:
determine a switching duty cycle to be applied to at least one terminal set of a plurality of terminal sets comprising two or more adjacent terminals in the series; and
activate a relay in electrical communication with the at least one of the terminal sets in the series using a pulse-width modulated signal having the determined switching duty cycle.
